(19) United States
(12) Patent Application Publication
(10) Pub. No.: US 2007/0199336 A1
(43) Pub. Date: Aug. 30, 2007

(54) System and method of controlling environmental conditioning equipment in an enclosure

(76) Inventor: Florence Tantot, Villebon-Sur-Yvette (FR)

Correspondence Address: HARNESS, DICKEY & PIERCE, P.L.C., P.O. BOX 828, BLOOMFIELD HILLS, MI, 48303, US

(21) Appl. No.: 11/511,875

(22) Filed: Aug. 29, 2006

Related U.S. Application Data
(63) Continuation of application No. PCT/FR05/00484, filed on Mar. 1, 2005.

(30) Foreign Application Priority Data
Mar. 1, 2004 (FR) 04/02072
Nov. 5, 2004 (FR) 04/11805

(51) Int. Cl. G01K 13/00; G05D 23/32

(52) U.S. Cl. 62/157; 62/129

(57) ABSTRACT

The invention relates to a system and device for controlling air-conditioning equipment, in particular to a method for controlling air-conditioning equipment in a chamber or the assembly of chambers consisting in pre-calculating at least one parameter selected between the temperature, chemical composition of the chamber or the assembly of chambers, the energy consumption of air-conditioning equipment and the energy production cost for a given time range by simulation carried out for an arbitrarily large number of explicit calculation formulae for a given time range and in selecting between said formulae the formulae called optimal explicit calculation formulae which meet predefined temperature and chemical composition restrictions and correspond to the minimisation of a cost function related to said energy production cost.

### CROSS-REFERENCE TO RELATED APPLICATIONS

This application is a continuation of PCT patent application Serial No. PCT/FR2005/000484 filed Mar. 1, 2005, which claims priority to French patent application Serial Nos. FR 04/02072 filed Mar. 1, 2004 and FR 04/11805 filed Nov. 5, 2004, all of which are incorporated by reference herein.

### BACKGROUND AND SUMMARY

The present invention relates to a system and method of controlling environmental conditioning equipment.

Environmental conditioning equipment provides the function of conditioning the temperature and the chemical composition of a substance, called ambient substance, contained in an enclosure or a set of enclosures, in order for this temperature and this chemical composition to respect certain predefined constraints. The environmental conditioning equipment consists of the following equipment:
equipment that has the function of heating or cooling the ambient substance;
equipment that has the function of heating or cooling an intermediate substance other than the ambient substance, of making it circulate, of storing it, of removing it from storage or of transferring the heat or the cold from this intermediate substance to the ambient substance or to another intermediate substance;
equipment that has the function of changing the chemical composition of the ambient substance by means, by way of non-limiting example, of adding or removing certain chemical elements, or replacing a part of the ambient substance with a substance that has a different chemical composition;
equipment that has the function of homogenising the temperature or the chemical composition of the ambient substance; and
equipment combining several of the functions defined above.

By way of non-limiting example, the enclosure can be a room in a building, the ambient substance can be the ambient air contained in the room, and the constraint can be the minimum and maximum temperatures that can be tolerated at each time of the day, as well as the maximum percentage of carbon dioxide contained in the ambient air. The environmental conditioning equipment can then consist of:
a boiler that has the function of heating an intermediate substance (water);
a set of pumps and pipes that have the function of carrying the hot water to the radiators and carrying it back to the boiler;
a set of radiators that have the function of transferring the heat from the water to the ambient air; and
a vent with adjustable shutter, that makes it possible to ensure the renewal of the air.

The environmental conditioning equipment operates using energy. The cost price of the energy depends on the energy source used, the amount of energy consumed, the time at which it is consumed and other factors. The environmental conditioning equipment must be controlled so as to adjust its operation in such a manner that the temperature and the chemical composition of the ambient substance conform to the predefined constraints. Traditionally one of the following types of control systems is used:
manual control systems, which require human intervention for any adjustment of the operation of the environmental conditioning equipment. These devices have the disadvantage of requiring numerous human interventions; or
automatic control systems, which are capable of adjusting the operation of the environmental conditioning equipment without requiring any systematic human intervention. With such systems, the commands sent to the environmental conditioning equipment are the result of an explicit, predefined calculation formula applied to the measured values of a certain number of environmental variables.

The prior art already knew U.S. Pat. No. 6,185,483, which describes a system for controlling an energy storage device connected to an environmental control system such as an air conditioner. The controller comprises a real-time data structure that corresponds to the price of one unit of energy according to time (for example, throughout the day). Calculation heuristics are then applied to these data in real time. These heuristics are predefined models calculated one time only when developing the product, which make it possible to program a response of the automaton in relation to a price profile.

The main disadvantage of such a method is the static nature of the optimisation algorithm, since the price models are predefined. Optimisation does not therefore take place in real time. This has the consequence of the selected optimum not being an absolute optimum, but rather a relative optimum, with regard to the predefined models. This also limits the possibility of taking into consideration a larger number of variables and possible correlations between these variables.

It should be noted that Japanese patent JP 62116844A2 describes a method for calculating a pseudo-optimum, also by using reference profiles and calculating the optimum of the prices according to this reference. Furthermore, certain documents of the prior art in the field of controlling environmental equipment use a genetic algorithm to calculate the commands. This is the case, for example, with Japanese patents JP 11108415A2 and JP 08005126. Once again, the use of genetic algorithms requires the setting of predefined thresholds in the decision, which results in inaccuracies in the optima chosen for fine variations of the parameters.

In addition, the prior art knew automatic methods for environmental equipment. This is the case, for example, of Japanese patent JP 03170735A2, which uses the temperature data for previous days to minimise an amount of cooling ice. Such methods are not methods for real-time optimisation of parameters for controlling an enclosure.

Finally, Japanese patent JP 202206785A2 relates to a method of optimising the production of equipment according to its consumption and the parameters associated with an enclosure. The constraints then affect the production data of the equipment. The technical problem resolved by this patent is therefore that of the production of equipment that is a source of heat. It should be understood that this patent does not provide a solution to the technical problem resolved by the present invention, which is the optimum management of various pieces of environmental equipment in order to respect constraints that affect an enclosure in which they are inserted.

Thus, the principle of the present invention is to affect the environmental parameters of the enclosure, and not only the energy production parameters, as was the case with the documents of the prior art. This is then implemented by capitalising on the tolerance of the environmental constraints of the actual enclosure. The present invention therefore aims to solve the disadvantages of the prior art by proposing a method of real-time optimisation in order to determine the commands sent to the environmental conditioning equipment of an enclosure in order to control the parameters of an enclosure.

To do so, the invention relates, in its broadest meaning, to a method of controlling environmental conditioning equipment for an enclosure or a set of enclosures, characterised in that it comprises at least the following steps, consisting of:
calculating in an anticipated manner, by simulation, at least one parameter selected from among the temperature and the chemical composition of the enclosure or set of enclosures, the energy consumption of the environmental conditioning equipment and the cost price of the consumed energy, forecast over a given time period, according to explicit calculation formulas during this time period, said calculation being performed by simulation for a randomly large number of explicit calculation formulas over a given time period; and
selecting from among said explicit calculation formulas the explicit calculation formulas, called optimum explicit calculation formulas, which respect the predefined constraints of temperature and chemical composition, and correspond to the minimisation of a cost function relating to said energy cost price.

Preferably, it also comprises a data-call step corresponding to at least one parameter selected from among the temperature and the chemical composition of the enclosure or set of enclosures, the energy consumption of the environmental conditioning equipment, and the cost price of the energy consumed, forecast over a given time period. Furthermore, it comprises a step of acquiring data relating to said enclosure or set of enclosures. It preferably also comprises a step of anticipated calculation of the amount of energy produced by the energy producing equipment and the cost price of producing this energy, according to the commands sent to this equipment and external data.

Said simulation step is advantageously also performed in relation to the energy production of the energy producing equipment and the cost price of the energy produced. In addition, said explicit calculation formula corresponds to a set of arithmetic and logical operations applied to the environmental variables in order to obtain a command sequence. Said minimisation of said cost function preferably corresponds to a minimisation of the cost price of the energy.

The invention also relates to a computer program, possibly stored in a recording medium, characterised in that it comprises a set of instructions that allow it to implement the method according to the invention. It also relates to a system for controlling environmental conditioning equipment for an enclosure or a set of enclosures, characterised in that it comprises means that enable it to:
calculate in an anticipated manner, by simulation, at least one parameter selected from among the temperature and the chemical composition of the enclosure or set of enclosures, the energy consumption of the environmental conditioning equipment and the cost price of the consumed energy, forecast over a given time period, according to an explicit calculation formula associated with at least one command sequence sent to the environmental conditioning equipment during this time period;
perform this calculation by simulation for a randomly large number of explicit calculation formulas over a given time period; and
select from among said simulated calculation formula the calculation formula, called optimum calculation formula, which respects the predefined constraints of temperature and chemical composition, and corresponds to the minimisation of a cost function relating to said energy cost price.

It preferably comprises a calculation subsystem, and:
the calculation subsystem can comprise telecommunication functions that enable it to acquire, in an automatic manner, data relating to weather forecasts, data relating to energy costs or other external data;
the calculation subsystem can implement optimisation algorithms such as the simplex algorithm or other similar algorithms, that make it possible to speed up the process of simulating and selecting the optimum command sequence;
the calculation subsystem can comprise functions that provide it with specific characteristics of tolerance to breakdowns and continuity of service;
the control system can comprise functions that enable it to control energy producing equipment such as, by way of non-limiting example, electricity generators or cogeneration plants;
the calculation subsystem can comprise functions that enable it to calculate, in an anticipated manner, the amount of energy produced by the energy producing equipment and the cost price of producing this energy, according to the commands sent to this equipment and external data such as, by way of non-limiting example, weather forecasts or data relating to the costs of other forms of energy. By way of non-limiting example, this energy producing equipment can consist of electricity generators, cogeneration plants, wind power stations, solar power stations or geothermal power stations;
the calculation subsystem can comprise functions that enable it (i) to calculate in an anticipated manner, by simulation, at least one parameter selected from among the temperature and the chemical composition of the enclosure or set of enclosures, the energy consumption of the environmental conditioning equipment, the energy production of the energy producing equipment, the cost price of the consumed energy and of the produced energy, forecast over a given time period, according to an explicit calculation formula associated with at least one command sequence sent to the environmental conditioning equipment and to the energy producing equipment during this time period; (ii) to perform this calculation by simulation for a randomly large number of explicit calculation formulas over a given time period; and (iii) to select the calculation formula, called optimum calculation formula, which respects the predefined constraints of temperature and chemical composition, and corresponds to the minimisation of a cost function relating to said energy cost price;
the calculation subsystem can comprise calculation and telecommunication functions that enable it to perform automatic transactions with external systems for buying and reselling energy;
the control system can comprise, in addition to the calculation subsystem, relay subsystems that make it possible to relay the commands from the calculation subsystem to the controlled equipment; the calculation subsystem and the relay subsystem then comprise communication functions that enable them to exchange data by means, by way of non-limiting example, of communication networks such as telephone networks, the internet, radio networks, local networks or carrier-current networks;
the relay subsystems can comprise calculation capacities that enable them to calculate the commands to be sent to the environmental conditioning equipment or to the energy producing equipment as the result of explicit calculation formulas applied to the measured values of a certain number of environmental variables;
the calculation subsystem and the relay subsystems can comprise functions that automatically enable the calculation subsystem to load and modify in the relay subsystems the explicit calculation formulas used by these relay subsystems to calculate commands to be sent to the controlled equipment;
the calculation subsystem can comprise functions that enable it (i) to calculate in an anticipated manner, by simulation, at least one parameter selected from among the temperature and the chemical composition of the enclosure or set of enclosures, the energy consumption of the environmental conditioning equipment, the energy production of the energy producing equipment, the cost price of the consumed energy and of the produced energy, forecast over a given time period, according to explicit calculation formulas sent to the relay subsystems at the start of this time period; (ii) to perform this calculation by simulation for a randomly large number of explicit calculation formulas; and (iii) to select the explicit calculation formulas, called optimum explicit calculation formulas, which respect the predefined constraints of temperature and chemical composition, and correspond to the minimisation of a cost function relating to said energy cost price;
the calculation subsystem can be located remotely in relation to the controlled equipment. In this case, the control system comprises, in addition to the calculation subsystem, relay subsystems that makes it possible to relay the commands from the calculation subsystem to the controlled equipment; the calculation subsystem can comprise calculation functions that enable it to calculate the optimum explicit calculation formulas or command sequences for equipment located on different geographical sites in order to, by way of non-limiting example, enable an optimisation of energy consumption in the event of the energy cost depending on the combined consumption of several geographical sites;
the calculation subsystem or the relay subsystems can comprise man-machine interfaces that enable them to describe the characteristics of the environmental conditioning equipment, the characteristics of the enclosure or set of enclosures, and the characteristics of the energy producing equipment, as well as other data. By way of non-limiting example, the man-machine interface makes it possible to describe the thermal and energetic characteristics of the environmental conditioning equipment and of the enclosure or set of enclosures, and the energetic and cost-price characteristics of the energy producing equipment;
the calculation subsystem can comprise calculation functions that enable it to select the explicit calculation formulas or command sequence using criteria other than the minimisation of the energy cost price and using constraints other than the predefined constraints of temperature and chemical composition;
by way of non-limiting application, the enclosure or set of enclosures can be a building or a group of buildings, the environmental conditioning equipment can be the environmental conditioning equipment of these buildings, the production equipment can be electricity generators, cogeneration plants, wind power stations, solar power stations or geothermal power stations, the calculation subsystem can be a computer or a set of computers, the relay subsystems can be electronic cards or sets of interconnected electronic cards, and the energy sources can be electricity, gas, heating oil or biomass; and
by way of further non-limiting application, the enclosure or set of enclosures can be a refrigerated warehouse or a cold room, or a set of refrigerated warehouses or cold rooms, and the environmental conditioning equipment can be the cold production and distribution equipment.

### BRIEF DESCRIPTION OF THE DRAWINGS

The invention will be better understood from the figures enclosed as examples, in which:

FIG. 1 shows the implementation of the system for controlling the commands of environmental conditioning equipment, and

FIG. 2 shows the steps of the process of optimisation of a control sequence according to the technical parameters of an enclosure and the dynamic parameters of environment and price.

### DETAILED DESCRIPTION

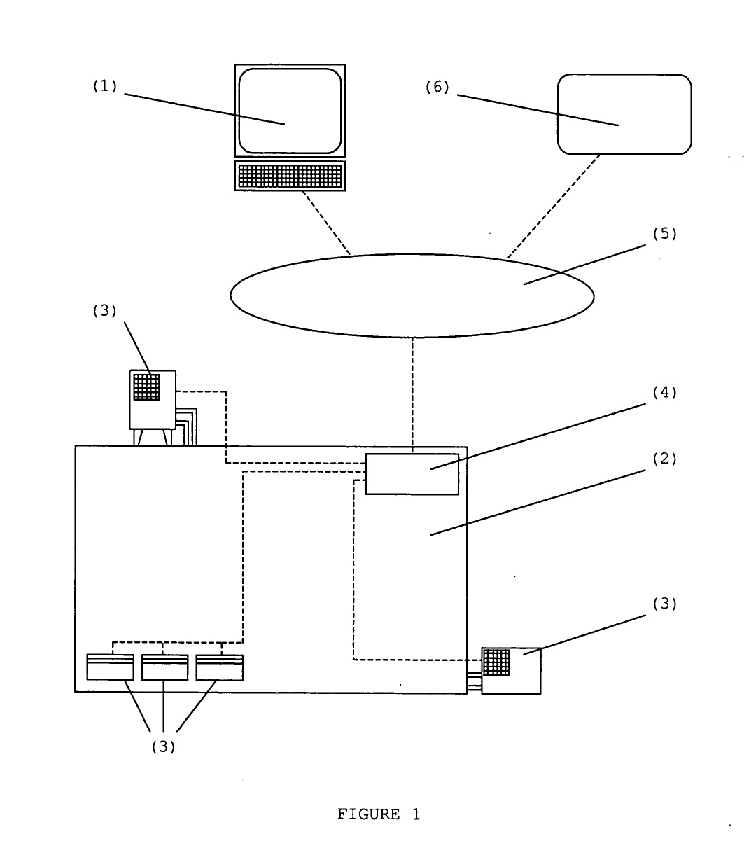

The following is a description of a specific embodiment of the invention shown in FIG. 1. This implementation method is especially suitable for the processing of external variables such as temperature or chemical compositions. The user can then choose what type of variable is to be considered in the optimisation calculations. Variables of this type, called inertial, actually have properties of diffusion in the enclosure to be controlled. It is understood that the system described remains valid for any kind of variable that those of ordinary skill in the art deem suitable with a view to controlling the environmental conditioning equipment.

FIG. 1 shows one embodiment of the system according to the invention. This embodiment of the invention uses a computer (1) in a remote location in relation to a building (2) containing environmental conditioning equipment (3), and an electronic card (4) that provides an interface with the environmental conditioning equipment (3). The computer (1) and the electronic interface card (4) each have functions that allow them to communicate over a remote communication network (5). In this embodiment of the invention, the calculation subsystem is the computer (1) and the relay subsystem is the electronic interface card (4).

The computer (1) contains a computer program that includes the following functions:
graphic interface that allows a human operator to describe the characteristics of the environmental conditioning equipment (3) and of the building (2),
automatic access by means of the remote communication network (5) with an external data server (6) for downloading the hourly prices of electricity for the next 24 hours, as well as the weather forecasts for the next 24 hours,
automatic calculation of the temperature of the building (2) over a given time period, according to the command sequence of the environmental conditioning equipment (3) during this time period,
automatic selection, by iteration and simulation of a large number of command sequences, of the command sequence that respects the minimum and maximum temperature constraints and corresponds to the minimum energy cost, and
automatic transmission to the environmental conditioning equipment (3), at every instant during the time period, of the commands that correspond to the selected sequence, by means of the remote communication network (5) and the electronic interface card (4).

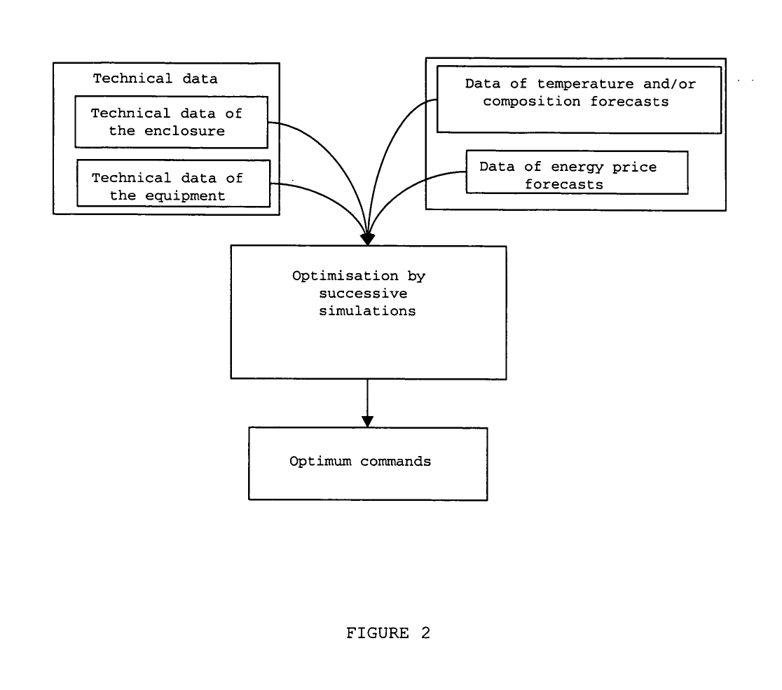

As shown in FIG. 2, the method according to the invention can be implemented by a computer program that can be installed on an equipment control station, or on a remote server. This method comprises a first step for the acquiring or calling relevant data for the optimisation. These data are, on the one hand, technical data relating to the actual enclosure, such as, for example, insulation coefficients, and technical data relating to the environmental conditioning equipment, such as the power they require for their operation. These data can be dynamic or fixed as static parameters for a more or less long period, if the characteristics of the equipment and the enclosure do not change. The temperature and/or chemical composition constraints are also entered in order to perform the optimisation.

The seconds step is the acquisition of dynamic data relating to the temperature and/or chemical composition in the environment of the enclosure over a given period. These data can be obtained by means of daily forecasts using a remote server, automatically downloaded, or entered as parameters in a dynamic manner. The dynamic data of the price of energy over a predetermined period are also entered as parameters. Likewise, these data are acquired automatically via a specialised server on a network or by means of any other acquisition method.

In a general manner and to ensure better understanding, the technical data will be called pseudo-static data, since their typical variation times are shorter than those of the dynamic temperature, composition and price variables. All of these data associated with the enclosure, pseudo-static and dynamic, which are acquired in a pseudo-static manner or dynamic manner are entered in the optimiser, which simulates all the combinations of command sequences over a period in order to optimise a cost function linked to the cost price of the energy and possibly to other cost parameters. The optimum sequence having then been determined, it is applied to all the environmental conditioning equipment in the enclosure.

Furthermore, the method according to the invention takes into account external variables (or environmental variables) that correspond, for example, to uncertainty relating to the weather forecasts or to parameters obtained by sensors. The command sequences are therefore generalised in the form of explicit calculation formulas, which correspond to the choice of a specific command sequence according to these external variables (or environment variables). For a given external variable x, the explicit calculation formula is therefore presented in the following simplified form:
F: If {x=a} then apply command sequence s(a)
If {x=b} then apply command sequence s(b).
The values a and b correspond, for example, to the top and bottom limits of uncertainty regarding the outside temperature and/or the outside chemical composition, or to a threshold value of the power consumed by stopping the controls.

According to this formalism, a command sequence therefore corresponds to an explicit calculation function when the external parameters are fixed. It is of the type {apply a temperature of 10° to such equipment during one hour, then apply 12° during 30 minutes}. The explicit calculation formula therefore corresponds to a set of arithmetic and logical operations applied to the environmental variables in order to obtain a command sequence.

According to the invention, the optimisation is performed on the explicit calculation formulas F by simulating, on a randomly large number of iterations over a given time period, the external variables and the associated optimum command sequences. The calculation formula that enables the minimisation of a cost function is called optimum calculation formula.

According to a first embodiment of the invention, the cost function is simply equal to the price of the energy to be paid over the period. The optimum sequence is therefore the sequence that minimises the price to be paid while respecting the operating constraints. According to a second embodiment of the invention, it is possible to depart from the initial constraints in the event of financial compensation. This type of compensation defines a new cost function, which is that on which the optimisation is performed. According to this embodiment, a financial compensation is then obtained if any of the temperature or composition constraints are not respected.

The choice of one or another of these embodiments (cost minimisation, or a more complex cost function) can possibly be entered as a parameter in the optimiser following utilisation or regulation contracts issued by the user. The system described above is therefore capable of implementing the process shown in FIG. 2. By way of non-limiting example, the invention can be used for energy management of services buildings, in particular shopping centres and offices.

The invention claimed is:

1. A system for controlling environmental conditioning equipment for an enclosure or a set of enclosures, the system comprising:
a computer operable to calculate in an anticipated manner, by simulation, at least one parameter selected from among the temperature and the chemical composition of the enclosure or set of enclosures, the energy consumption of the environmental conditioning equipment and the cost price of the consumed energy, forecast over a given time period, according to an explicit calculation formula associated with at least one command sequence sent to the environmental conditioning equipment during this time period;
the computer operable to perform this calculation by simulation for a randomly large number of explicit calculation formulas over a given time period; and
the computer operable to select from among the simulated calculation formulas the calculation formula, called optimum calculation formula, which respects the predefined constraints of temperature and chemical composition, and corresponds to the minimisation of a cost function relating to the energy cost price.

2. The system according to claim 1, further comprising communication means for the acquisition of external data, for example but not necessarily, weather forecast data or data relating to energy availability conditions.

3. The system according to claim 1, further comprising a calculation subsystem implementing optimisation algorithms such as the simplex algorithm or other similar algorithms, that make it possible to speed up the process of simulating and selecting the optimum command sequence.

4. The system according to claim 1, further comprising instructions including functions that provide it with specific characteristics of tolerance to breakdowns and continuity of service.

5. The system according to claim 1, further comprising instructions including functions that enable it to control energy producing equipment.

6. The system according to claim 1, further comprising instructions including functions that enable it to calculate, in an anticipated manner, the amount of energy produced by the energy producing equipment and the cost price of producing this energy, according to an explicit calculation formula associated with at least one command sequence sent to this equipment and to external data.

7. The system according to claim 5, further comprising instructions including functions that enable it (i) to calculate in an anticipated manner, by simulation, at least one parameter selected from among the temperature and the chemical composition of the enclosure or set of enclosures, the energy consumption of the environmental conditioning equipment, the energy production of the energy producing equipment, and the cost price of the consumed energy and of the produced energy, forecast over a given time period, according to an explicit calculation formula associated with at least one command sequence sent to the environmental conditioning equipment and to the energy producing equipment during this time period, (ii) to perform this calculation by simulation for a randomly large number of explicit calculation formulas over a given time period, and (iii) to select from among the simulated calculation formulas the calculation formula, called optimum calculation formula, which respects the predefined constraints of temperature and chemical composition, and corresponds to the minimisation of a cost function relating to the energy cost price.

8. The system according to claim 1, further comprising calculation and communication means that enable it to implement automatic transactional sub-processes with external systems.

9. The system according to claim 1, further comprising a calculation subsystem and relay subsystems that enable it to relay the commands from the calculation subsystem to the controlled equipment; the calculation subsystem and the relay subsystems then comprise communication functions that enable them to exchange data.

10. The system according to claim 9, wherein the relay subsystems comprise calculation capacities that enable them to calculate the commands to be sent to the environmental conditioning equipment or to the energy producing equipment as the result of explicit calculation formulas applied to the measured values of a certain number of environmental variables.

11. The system according to claim 10, wherein the calculation subsystem and the relay subsystems comprise functions that automatically enable the calculation subsystem to load and modify in the relay subsystems the explicit calculation formulas used by these relay subsystems to calculate commands to be sent to the controlled equipment.

12. The system according to claim 10, wherein the calculation subsystem comprises functions that enable it (i) to calculate in an anticipated manner, by simulation, at least one parameter selected from among the temperature and the chemical composition of the enclosure or set of enclosures, the energy consumption of the environmental conditioning equipment, the energy production of the energy producing equipment, the cost price of the consumed energy and of the produced energy, forecast over a given time period, according to explicit calculation formulas sent to the relay subsystems at the start of this time period, (ii) to perform this calculation by simulation for a randomly large number of explicit calculation formulas, and (iii) to select the explicit calculation formulas, called optimum explicit calculation formulas, which respect the predefined constraints of temperature and chemical composition, and correspond to the minimisation of a cost function relating to the energy cost price.

13. The system according to claim 9, wherein the calculation subsystem is located remotely in relation to the controlled equipment.

14. The system according to claim 13, wherein the calculation subsystem comprises calculation functions that enable it to calculate the optimum explicit calculation formulas or command sequences for equipment located on different geographical sites.

15. The system according to claim 9, wherein the calculation subsystem or the relay subsystems comprise man-machine interfaces that enable them to describe the characteristics of the environmental conditioning equipment, the characteristics of the enclosure or set of enclosures, and the characteristics of the energy producing equipment, as well as other data.

16. The system according to claim 1, wherein the enclosure or set of enclosures are a building or a group of buildings, the environmental conditioning equipment is the environmental conditioning equipment of these buildings, the production equipment is made up of electricity generators, cogeneration plants, wind power stations, solar power stations or geothermal power stations, the calculation subsystem is a computer or a set of computers, the relay subsystems are electronic cards or sets of interconnected electronic cards, and the energy sources are electricity, gas, heating oil or biomass.

17. The system according to claim 1, wherein the enclosure or set of enclosures are a refrigerated warehouse or a cold room, or a set of refrigerated warehouses or cold rooms, and the environmental conditioning equipment consists of the cold production and distribution equipment.

18. A method of controlling environmental conditioning equipment for an enclosure or a set of enclosures, the method comprising:
calculating in an anticipated manner, by simulation, at least one parameter selected from among the temperature and the chemical composition of the enclosure or set of enclosures, the energy consumption of the environmental conditioning equipment and the cost price of the consumed energy, forecast over a given time period, according to explicit calculation formulas during this time period, the calculation being performed by simulation for a randomly large number of explicit calculation formulas over a given time period; and
selecting from among said explicit calculation formulas the explicit calculation formulas, called optimum explicit calculation formulas, which respect the predefined constraints of temperature and chemical composition, and correspond to the minimisation of a cost function related to the energy cost price.

19. The method of controlling environmental conditioning equipment for an enclosure or a set of enclosures according to claim 18, further comprising a data-call step corresponding to at least one parameter selected from among the temperature and the chemical composition of the enclosure or set of enclosures, the energy consumption of the environmental conditioning equipment, and the cost price of the energy consumed, forecast over a given time period.

20. The method of controlling environmental conditioning equipment for an enclosure or a set of enclosures according to claim 18, further comprising acquiring data associated with said enclosure or set of enclosures.

21. The method of controlling environmental conditioning equipment for an enclosure or a set of enclosures according to claim 18, further comprising anticipated calculation of the amount of energy produced by the energy producing equipment and the cost price of producing this energy, according to the commands sent to this equipment and external data.

22. The method of controlling environmental conditioning equipment for an enclosure or a set of enclosures according to claim 21, wherein the simulation step is also performed in relation to the energy production of the energy producing equipment and the cost price of the energy produced.

23. The method of controlling environmental conditioning equipment for an enclosure or a set of enclosures according to claim 18, wherein the explicit calculation formula corresponds to a set of arithmetic and logical operations applied to the environmental variables in order to obtain a command sequence.

24. The method of controlling environmental conditioning equipment for an enclosure or a set of enclosures according to claim 18, wherein the minimisation of the cost function corresponds to a minimisation of the cost price of the energy.

25. A computer program stored in memory, the program comprising:
a first set of instructions operable to obtain weather forecasts and energy prices;
a second set of instructions operable to acquire data relating to at least one enclosure;
a third set of instructions operable to determine energy consumption of environmental conditioning equipment associated with the enclosure;
a fourth set of instructions operable to calculate an anticipated amount of energy production needed; and
a fifth set of instructions optimizing, through automatic simulations, energy consumption for the environmental conditioning equipment.

26. The program of claim 25, further comprising:
a sixth set of instructions automatically purchasing energy based on the optimizing instructions; and
a seventh set of instructions controlling performance of the environmental conditioning equipment based at least in part on the optimizing instructions; and
the enclosure being at least one building.
